(19) United States
(12) Patent Application Publication
(10) Pub. No.: US 2024/0031289 A1
(43) Pub. Date: Jan. 25, 2024

(54) NETWORK INTERFACE DEVICE LOOK-UP OPERATIONS

(71) Applicant: Intel Corporation, Santa Clara, CA (US)

(72) Inventors: Arunkumar BALAKRISHNAN, Santa Clara, CA (US); Anurag AGRAWAL, Santa Clara, CA (US); Elazar COHEN, Haifa (IL); Anjali Singhai JAIN, Portland, OR (US)

(21) Appl. No.: 18/375,480

(22) Filed: Sep. 30, 2023

Related U.S. Application Data
(60) Provisional application No. 63/466,007, filed on May 12, 2023.

(51) Int. Cl. H04L 45/748; H04L 45/00; H04L 12/46

(52) U.S. Cl. CPC H04L 45/748; H04L 45/566; H04L 12/4633

(57) ABSTRACT

Examples described herein relate to a network interface device. The network interface device can include circuitry that is to: perform a route lookup for a packet based on first and second lookup operations, wherein the first lookup operation comprises a longest prefix match (LPM) to output a route identifier based on a destination Internet Protocol (IP) address of the packet and wherein the second look up operation comprises an exact match operation to determine an action based on the route identifier and a packet header.

### RELATED APPLICATION

This application claims priority to U.S. Provisional Application No. 63/466,007, filed May 12, 2023. The entire contents of that application is incorporated by reference in its entirety.

### BACKGROUND

Routing tables are used by network interface cards (NICs), Infrastructure Processing Units (IPUs), and Data Processing Units (DPUs) to look up egress ports from which to transmit packets based on a sender identifier and destination Internet Protocol (IP) address. To look up an egress port, general purpose central processing unit (CPU) cores can execute software to perform match-action operations on trie structures of a routing table stored in memory. However, for routing table look up, as a number of entries in trie structures increase, memory usage and consumed CPU cycles increase. As the depth of the trie increases, latency of table look up can increase and become a bottleneck due to limitations on available CPU cycles utilized for searching. In addition, a CPU cache may not be large enough to store exact match tables and accesses to memory to retrieve entries in the trie can introduce additional latency and reduce available memory bandwidth for other uses.

### BRIEF DESCRIPTION OF THE DRAWINGS

FIG. 1 depicts an example network interface device.

FIG. 2 depicts an example network interface device.

FIG. 3 depicts an example network interface device.

FIG. 4 depicts an example network interface device.

FIGS. 5-7 depict examples of look up operations.

FIG. 8 depicts an example process.

FIG. 9 depicts an example system.

### DETAILED DESCRIPTION

To determine an egress port, a longest prefix match (LPM) search of a trie data structure can be performed. For context aware routing, which routes packets transmitted by tunneling (e.g., VXLAN), a number of trie nodes can scale up or increase. Hence, on-chip memory of the switch may be insufficiently large to store the trie nodes and trie nodes may be stored in memory off-chip from the switch, which can introduce increases a time to perform a lookup and can increase latency for forwarding operations.

Various examples described herein can at least partially address capacity constraints in on-chip memory for entries of an LPM table to lookup an action for a packet by performing LPM and/or Wild Card Match (WCM) lookup of entries of a route identifier based on a destination Internet Protocol (IP) address followed by exact match lookup of an action to perform on the packet based on the route identifier and at least one packet header field value. For example, the at least one packet header field value can include a virtual local area network identifier, such as a virtual tunnel identifier. In some examples, the packet can be transmitted using a tunnel protocol and the virtual tunnel identifier can be tunnel identifier. In addition, runtime programming of the table entries can be performed, as described herein.

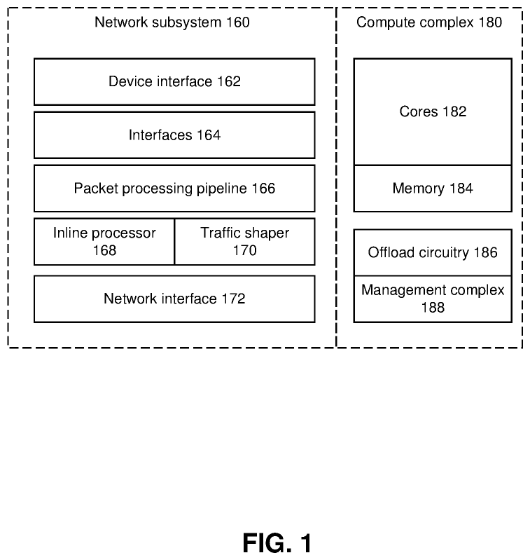

FIG. 1 depicts an example system. Various examples of packet processing device or data plane circuitry 110 can utilize components of the system of FIG. 1 to determine an egress port and one or more actions to perform on a packet by looking up a route identifier based on LPM and/or WCM and the egress port based on the route identifier based on exact match lookup. Network subsystem 160 can be communicatively coupled to compute complex 180. Device interface 162 can provide an interface to communicate with a host. Various examples of device interface 162 can utilize protocols based on Peripheral Component Interconnect Express (PCIe), Compute Express Link (CXL), or others as well as virtual device interface such as virtual device interfaces.

Interfaces 164 can initiate and terminate at least offloaded remote direct memory access (RDMA) operations, Non-volatile memory express (NVMe) reads or writes operations, and LAN operations. Packet processing pipeline 166 can perform packet processing (e.g., packet header and/or packet payload) based on a configuration and support quality of service (QoS) and telemetry reporting. Packet processing pipeline 166 (e.g., ASICs, FPGAs, or other circuitry) can perform lookup of tables stored in internal memory (e.g., memory 184) and/or external memory. Inline processor 168 can perform offloaded encryption or decryption of packet communications (e.g., Internet Protocol Security (IPSec) or others). Traffic shaper 170 can schedule transmission of communications. Network interface 172 can provide an interface at least to an Ethernet network by media access control (MAC) and serializer/de-serializer (Serdes) operations.

Cores 182 can be configured to perform infrastructure operations such as storage initiator, Transport Layer Security (TLS) proxy, virtual switch (e.g., vSwitch), or other operations. Memory 184 can store applications and data to be performed or processed. Offload circuitry 186 can perform at least cryptographic and compression operations for host or use by compute complex 180. Management complex 188 can perform secure boot, life cycle management and management of network subsystem 160 and/or compute complex 180.

A packet may refer to various formatted collections of bits that may be sent across a network, such as Ethernet frames, Internet Protocol (IP) packets, Transmission Control Protocol (TCP) segments, User Datagram Protocol (UDP) datagrams, etc. For example, a packet can include one or more headers and a payload and encapsulate one or more packets having headers and/or payloads. One or more headers can include one or more of: Ethernet header, IP header, TCP header, UDP header, or InfiniB and Trade Association (IBTA) header. A header can be used to control a flow of the packet through a network to a destination. A header can include information related to addressing, routing, and protocol version. For example, an IP header can include information about the version of the IP protocol, the length of the header, the type of service used, the packet's Time to Live (TTL), the source and destination address. For example, a header can include N-tuple information such as source address, destination address, IP protocol, transport layer source port, and/or destination port.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and/or destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

For a packet, packet processing pipeline 166 can perform context aware routing based on at least two inputs: a preface metadata and destination address. Preface metadata can include a virtual network identifier (VNI) or tunnel identifier associated with the packet. A VNI can represent a VXLAN tunnel identifier for a tenant and can map to multiple sender virtual machines (VMs), containers, applications, services, or others within a host system. A destination address can include at least IPv4 address (e.g., 32b) or IPv6 address (128b). A routing table can store a list of inputs and lookup results. Lookup results can include one or more of: a next hop address, output port, and/or other action to perform on the packet. A set of actions to perform on the packet can include at least: sending the packet to a particular egress port, modifying one or more packet header field values, dropping the packet, mirroring the packet to a mirror buffer, etc. As described herein, packet processing pipeline 166 can perform LPM to determine a routing identifier for the packet and perform exact match lookup to determine a next hop address and an action to perform on the packet. To perform lookup operations, packet processing pipeline 166 can access longest prefix match (LPM) tables and exact match tables stored in memory on chip-with network subsystem 160 and/or off-chip from network subsystem 160 (e.g., connected via a device interface such as PCIe or CXL).

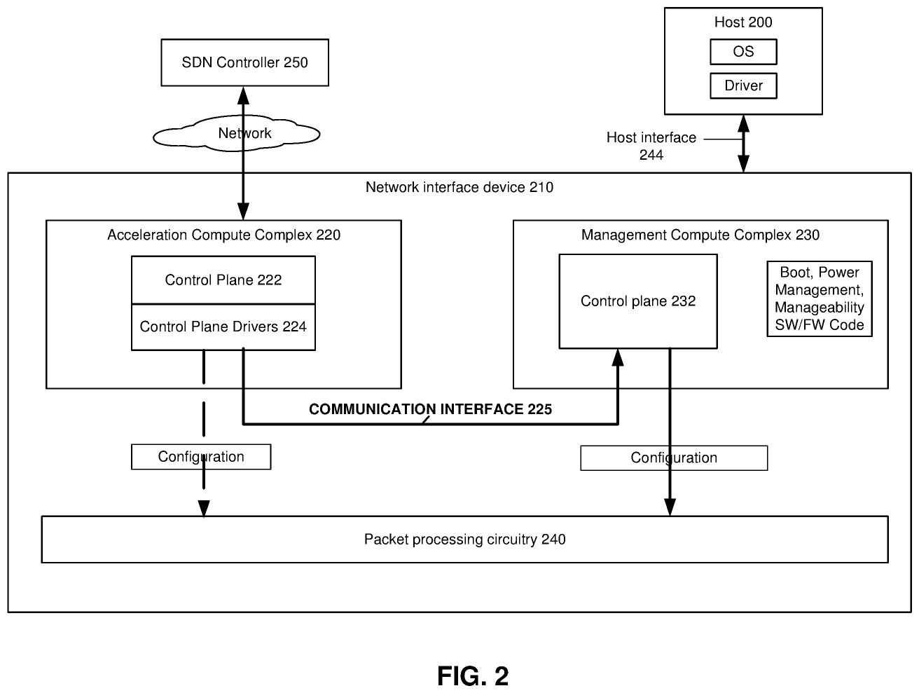

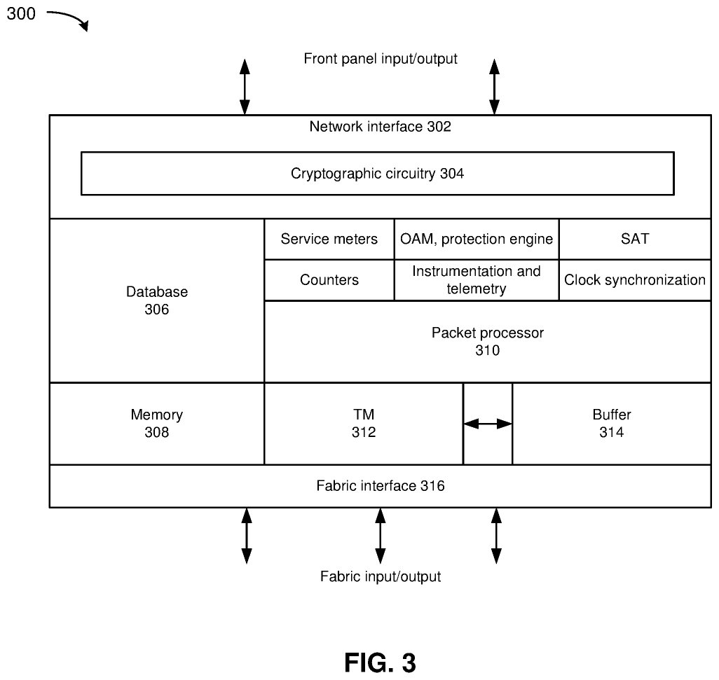

FIG. 2 depicts an example network interface device. Host 200 can include processors, memory devices, device interfaces, as well as other circuitry such as described with respect to one or more of FIGS. 1, 3, and/or 4. Processors of host 200 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 210 to utilize one or more control planes to communicate with software defined networking (SDN) controller 250 via a network to configure operation of the one or more control planes. Host 200 can be coupled to network interface device 210 via a host or device interface 244.

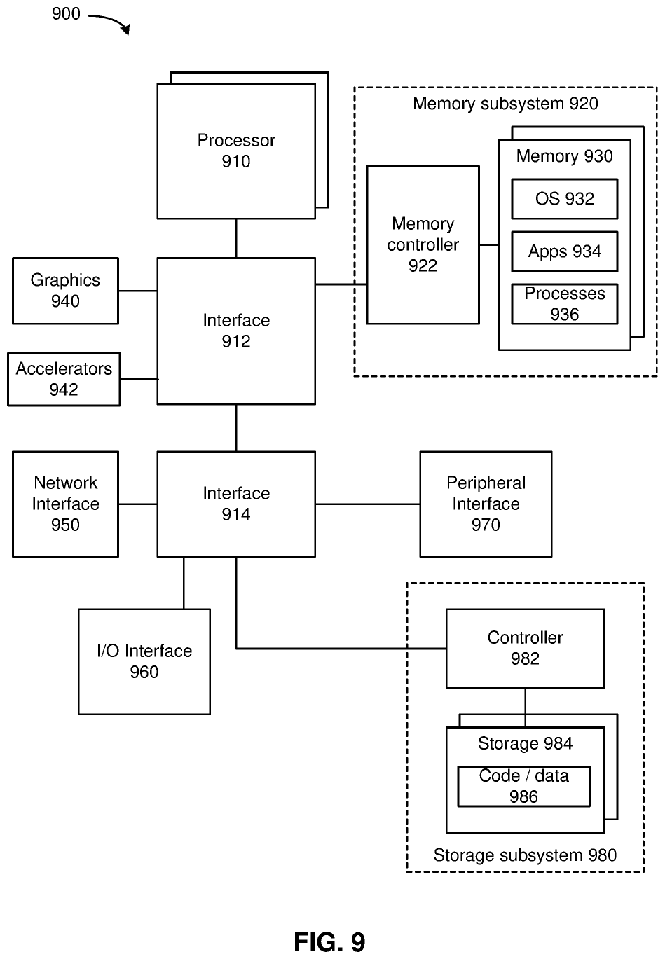

Network interface device 210 can include multiple compute complexes, such as an Acceleration Compute Complex (ACC) 220 and Management Compute Complex (MCC) 230, as well as packet processing circuitry 240 and network interface technologies for communication with other devices via a network. ACC 220 can be implemented as one or more of: a microprocessor, processor, accelerator, field programmable gate array (FPGA), application specific integrated circuit (ASIC) or circuitry described at least with respect to FIGS. 1 and/or 2. Similarly, MCC 230 can be implemented as one or more of: a microprocessor, processor, accelerator, field programmable gate array (FPGA), application specific integrated circuit (ASIC) or circuitry described at least with respect to FIG. 9. In some examples, ACC 220 and MCC 230 can be implemented as separate cores in a CPU, different cores in different CPUs, different processors in a same integrated circuit, different processors in different integrated circuit.

Network interface device 210 can be implemented as one or more of: a microprocessor, processor, accelerator, field programmable gate array (FPGA), application specific integrated circuit (ASIC) or circuitry described at least with respect to FIG. 9. Packet processing pipeline circuitry 240 can process packets as directed or configured by one or more control planes executed by multiple compute complexes. In some examples, ACC 220 and MCC 230 can execute respective control planes 222 and 232.

SDN controller 250 can upgrade or reconfigure software executing on ACC 220 (e.g., control plane 222 and/or control plane 232) through contents of packets received through packet processing device 210. In some examples, ACC 220 can execute control plane operating system (OS) (e.g., Linux) and/or a control plane application 222 (e.g., user space or kernel modules) used by SDN controller 250 to configure operation of packet processing pipeline 240. Control plane application 222 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 250 can communicate with ACC 220 using a remote procedure call (RPC) such as Google remote procedure call (gRPC) or other service and ACC 220 can convert the request to target specific protocol buffer (protobuf) request to MCC 230. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 250 can provide packet processing rules for performance by ACC 220. For example, ACC 220 can program table rules (e.g., header field match and corresponding action) applied by packet processing pipeline circuitry 240 based on change in policy and changes in VMs, containers, microservices, applications, or other processes. ACC 220 can be configured to provide network policy as flow cache rules into a table to configure operation of packet processing pipeline 240. For example, the ACC-executed control plane application 222 can configure rule tables applied by packet processing pipeline circuitry 240 with rules to define a traffic destination based on packet type and content. ACC 220 can program table rules (e.g., match-action) into memory accessible to packet processing pipeline circuitry 240 based on change in policy and changes in virtual machines (VMs) or other processes.

For example, ACC 220 can execute a virtual switch such as vSwitch or Open vSwitch (OVS), Stratum, or Vector Packet Processing (VPP) that provides communications between virtual machines executed by host 200 or with other devices connected to a network. For example, ACC 220 can configure packet processing pipeline circuitry 240 as to which VM is to receive traffic and what kind of traffic a VM can transmit. For example, packet processing pipeline circuitry 240 can execute a virtual switch such as vSwitch or Open vSwitch that provides communications between virtual machines executed by host 200 and packet processing device 210.

MCC 230 can execute a host management control plane, global resource manager, and perform hardware registers configuration. Control plane 232 executed by MCC 230 can perform provisioning and configuration of packet processing circuitry 240. For example, a VM executing on host 200 can utilize packet processing device 210 to receive or transmit packet traffic. MCC 230 can execute boot, power, management, and manageability software (SW) or firmware (FW) code to boot and initialize the packet processing device 210, manage the device power consumption, provide connectivity to a management controller (e.g., Baseboard Management Controller (BMC)), and other operations.

One or both control planes of ACC 220 and MCC 230 can define traffic routing table content and network topology applied by packet processing circuitry 240 to select a path of a packet in a network to a next hop or to a destination network-connected device. For example, a VM executing on host 200 can utilize packet processing device 210 to receive or transmit packet traffic.

ACC 220 can execute control plane drivers to communicate with MCC 230. At least to provide a configuration and provisioning interface between control planes 222 and 232, communication interface 225 can provide control-plane-to-control plane communications. Control plane 232 can perform a gatekeeper operation for configuration of shared resources. For example, via communication interface 225, ACC control plane 222 can communicate with control plane 232 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 225 can be utilized by a negotiation protocol and configuration protocol running between ACC control plane 222 and MCC control plane 232. Communication interface 225 can include a general purpose mailbox for different operations performed by packet processing circuitry 240. Examples of operations of packet processing circuitry 240 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 225 can include one or more mailboxes accessible as registers or memory addresses. For communications from control plane 222 to control plane 232, communications can be written to the one or more mailboxes by control plane drivers 224. For communications from control plane 232 to control plane 222, communications can be written to the one or more mailboxes. Communications written to mailboxes can include descriptors which include message opcode, message error, message parameters, and other information. Communications written to mailboxes can include defined format messages that convey data.

Communication interface 225 can provide communications based on writes or reads to particular memory addresses (e.g., dynamic random access memory (DRAM)), registers, other mailbox that is written-to and read-from to pass commands and data. To provide for secure communications between control planes 222 and 232, registers and memory addresses (and memory address translations) for communications can be available only to be written to or read from by control planes 222 and 232 or cloud service provider (CSP) software executing on ACC 220 and device vendor software, embedded software, or firmware executing on MCC 230. Communication interface 225 can support communications between multiple different compute complexes such as from host 200 to MCC 230, host 200 to ACC 220, MCC 230 to ACC 220, baseboard management controller (BMC) to MCC 230, BMC to ACC 220, or BMC to host 200.

Packet processing circuitry 240 can determine an action for a packet by performing LPM and/or WCM lookup of entries of a route identifier based on a destination Internet Protocol (IP) address followed by exact match lookup of an action to perform on the packet based on the route identifier and at least one packet header field value.

Packet processing circuitry 240 can be implemented using one or more of: application specific integrated circuit (ASIC), field programmable gate array (FPGA), processors executing software, or other circuitry. Control plane 222 and/or 232 can configure packet processing pipeline circuitry 240 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 220 or MCC 230. In some examples, a P4 program can be compiled and provided to MCC 230 to configure packet processing circuitry 240. The following is a JSON configuration file that can be transmitted from ACC 220 to MCC 230 to get capabilities of packet processing circuitry 240 and/or other circuitry in packet processing device 210. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 3 depicts an example switch. Various examples can be used in or with a switch system on chip (SoC) to lookup an action for a packet by performing LPM or WCM lookup of entries of a route identifier based on a destination Internet Protocol (IP) address followed by exact match lookup of an action to perform on the packet based on the route identifier and at least one packet header field value. Switch 300 can include a network interface 300 that can provide an Ethernet consistent interface. Network interface 300 can support for 25 GbE, 50 GbE, 100 GbE, 200 GbE, 400 GbE Ethernet port interfaces. Cryptographic circuitry 304 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 306 can store a device's profile to configure operations of switch 300. Memory 308 can include High Bandwidth Memory (HBM) for packet buffering. Packet processor 310 can perform one or more of: packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 310 can be configured to perform packet expansion and header modification as described herein. Packet processor 310 can include one or more FPGAs. Buffer 314 can store one or more packets. Traffic manager (TM) 312 can provide per-subscriber bandwidth guarantees in accordance with service level agreements (SLAs) as well as performing hierarchical quality of service (QoS). Fabric interface 316 can include a serializer/de-serializer (SerDes) and provide an interface to a switch fabric.

For example, switch SoC 300 can be communicatively coupled to one or more ingress ports and one or more egress ports as well as a processor, memory, physical layer interfaces, communication medium, and other communication circuitry.

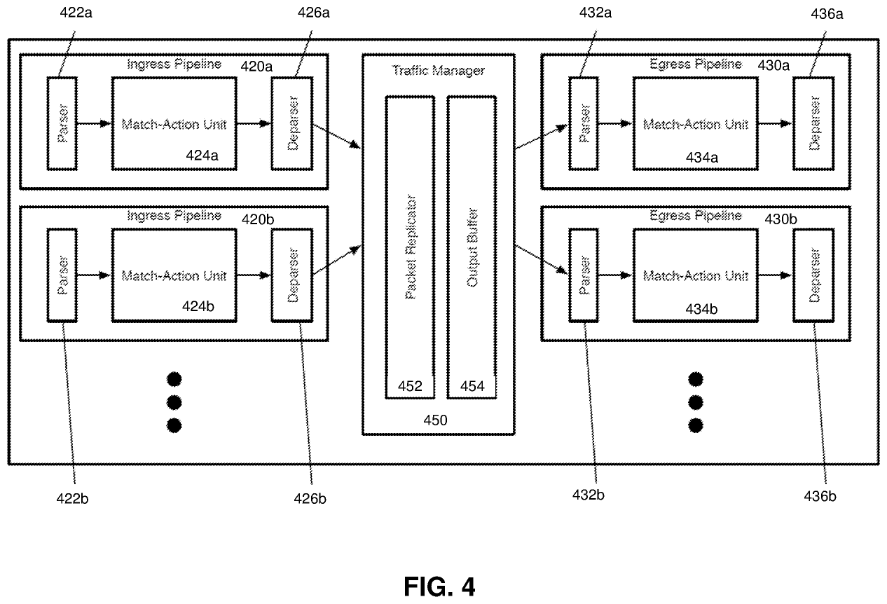

FIG. 4 depicts an example network forwarding system that can be used as a network interface device or router. For example, FIG. 4 illustrates several ingress pipelines 420, a traffic management unit (referred to as a traffic manager) 450, and several egress pipelines 430. For example, the system of FIG. 4 can be implemented in an SoC and the SoC can be communicatively coupled to one or more ingress ports and one or more egress ports as well as a processor, memory, physical layer interfaces, communication medium, and other communication circuitry.

Though shown as separate structures, in some examples the ingress pipelines 420 and the egress pipelines 430 can use the same circuitry resources. At least traffic manager 450 and egress pipelines 430 can determine an action to perform on a packet by performing LPM or WCM lookup of entries of a route identifier based on a destination Internet Protocol (IP) address followed by exact match lookup of an action to perform on the packet based on the route identifier and at least one packet header field value.

Operation of pipelines can be programmed using Programming Protocol-independent Packet Processors (P4), C, Python, Broadcom NPL, or x86 compatible executable binaries or other executable binaries. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

In some examples, in response to receiving a packet, the packet is directed to one of the ingress pipelines 420 where an ingress pipeline may correspond to one or more ports of a hardware forwarding element. After passing through the selected ingress pipeline 420, the packet is sent to the traffic manager 450, where the packet is enqueued and placed in the output buffer 454. In some examples, the ingress pipeline 420 that processes the packet specifies into which queue the packet is to be placed by the traffic manager 450 (e.g., based on the destination of the packet or a flow identifier of the packet). The traffic manager 450 then dispatches the packet to the appropriate egress pipeline 430 where an egress pipeline may correspond to one or more ports of the forwarding element. In some examples, there is no necessary correlation between which of the ingress pipelines 420 processes a packet and to which of the egress pipelines 430 the traffic manager 450 dispatches the packet. That is, a packet might be initially processed by ingress pipeline 420b after receipt through a first port, and then subsequently by egress pipeline 430a to be sent out a second port, etc.

A least one ingress pipeline 420 includes a parser 422, a chain of multiple match-action units or circuitry (MAUs) 424 to perform match-action lookup, and a deparser 426. Similarly, egress pipeline 430 can include a parser 432, a chain of MAUs 434, and a deparser 436. The parser 422 or 432, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 422 or 432 separates out the packet headers (up to a designated point) from the payload of the packet, and sends the payload (or the entire packet, including the headers and payload) directly to the deparser without passing through the MAU processing. Egress parser 432 can use additional metadata provided by the ingress pipeline to simplify its processing.

The MAUs 424 or 434 can perform processing on the packet data. In some examples, the MAUs includes a sequence of stages, with each stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, using MAU(s), packet processing, receipt of worker data, forwarding a packet header from a worker to a server, or insertion of computed result data into packets to be sent to workers, as described herein.

The deparser 426 or 436 can reconstruct the packet using the PHV as modified by the MAU 424 or 434 and the payload received directly from the parser 422 or 432. The deparser can construct a packet that can be sent out over the physical network, or to the traffic manager 450. In some examples, the deparser can construct this packet based on data received along with the PHV that specifies the protocols to include in the packet header, as well as its own stored list of data container locations for each possible protocol's header fields.

Traffic manager (TM) 450 can include a packet replicator 452 and output buffer 454. In some examples, TM 450 can provide packet copies to egress pipeline 430a-930b to perform packet expansion operations, as described herein. In some examples, the traffic manager 450 may include other components, such as a feedback generator for sending signals regarding output port failures, a series of queues and schedulers for these queues, queue state analysis components, as well as additional components. Packet replicator 452 of some examples performs replication for broadcast/multicast packets, generating multiple packets to be added to the output buffer (e.g., to be distributed to different egress pipelines).

The output buffer 454 can be part of a queuing and buffering system of the traffic manager in some examples. The traffic manager 450 can provide a shared buffer that accommodates any queuing delays in the egress pipelines. In some examples, this shared output buffer 454 can store packet data, while references (e.g., pointers) to that packet data are kept in different queues for each egress pipeline 430. The egress pipelines can request their respective data from the common data buffer using a queuing policy that is control-plane configurable. When a packet data reference reaches the head of its queue and is scheduled for dequeuing, the corresponding packet data can be read out of the output buffer 454 and into the corresponding egress pipeline 430.

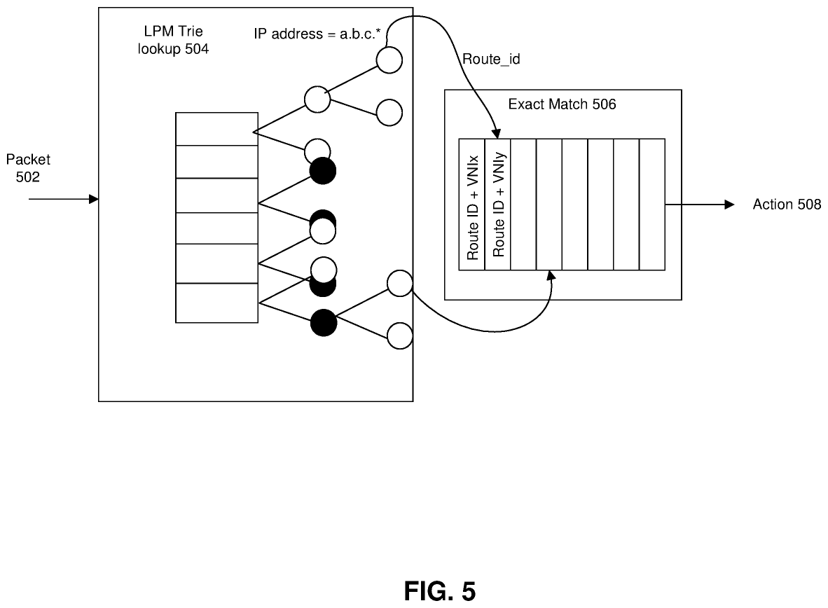

FIG. 5 depicts an example of LPM and exact match lookups. The lookup operations can be performed by a packet processing pipeline. Lookup can be as follows: At (1), packet processing pipeline can perform LPM trie lookup 504 on a destination IP address of packet 502 and for a match, provide a route_id for the destination IP address. The retrieved route_id, from lookup of a trie data structure, can be stored as metadata along with the packet in on-chip memory and/or off chip memory. At (2), packet processing pipeline can perform lookup in exact match lookup 506 of a tunnel identifier and route_id to determine a next hop address result and at least one action 508. For example, a tunnel identifier can include a VNI, such as a VNI from a VXLAN outer header packet header (e.g., “Virtual eXtensible Local Area Network (VXLAN): A Framework for Overlaying Virtualized Layer 2 Networks over Layer 3 Networks” RFC 7348 (2014)). In other words, the next hop can be determined based on a combination of route_id and tunnel identifier to find a next hop destination media access control (MAC) address. Note that a next hop can include a receiver process (e.g., VM, container, etc.) in a same host that executes a process that requested sending of the packet. LPM and exact match tables can be stored in internal and/or external memory. Actions can include: send to port and packet header modification. Packet header modification can include modification of outer source and/or destination MAC addresses.

Examples herein can overcome longest prefix match (LPM) table capacity constraints by rearranging the context preface and destination address lookup. In addition, runtime programming of the table entries can be performed. Offloading routing table lookup by access to LPM and exact match tables in order can potentially achieve improved packet processing performance (throughput and latency) because LPM can be performed using entries in the on-chip memory.

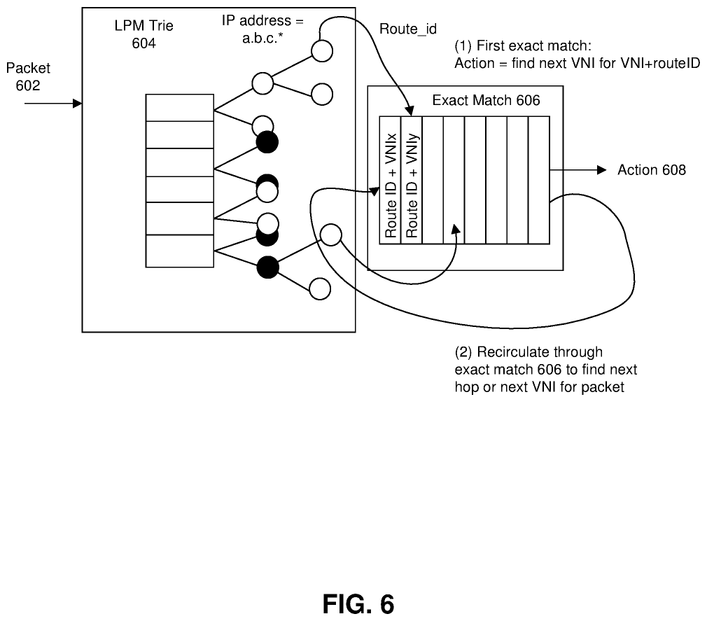

FIG. 6 depicts an example of lookup for a tunnel identifier along with destination IP address. The lookup operations can be performed by a packet processing pipeline for a network change (e.g., changing packet traversal from a first VLAN tunnel to a second VLAN tunnel). For example, packet 604 has a single destination IP address but is subject to a change of network. After traversal through LPM 604 and exact match 606, at (1) packet processing pipeline can perform lookup in exact match lookup 606 operation to identify the new VNI. At (2), based on a second traversal through exact match 606 using the same route ID and new VNI determine a next hop address result and at least one action 608. Action 608 can be to recirculate the packet (e.g., perform another lookup) for another exact match 606 operation to identify a second VNI for the same destination IP address. At (2), based on a second traversal through exact match 606 using a same route ID and the VNI from the packet, the second VNI or next hop (e.g., next network interface device to transmit the packet to or next switch) can be determined for the packet.

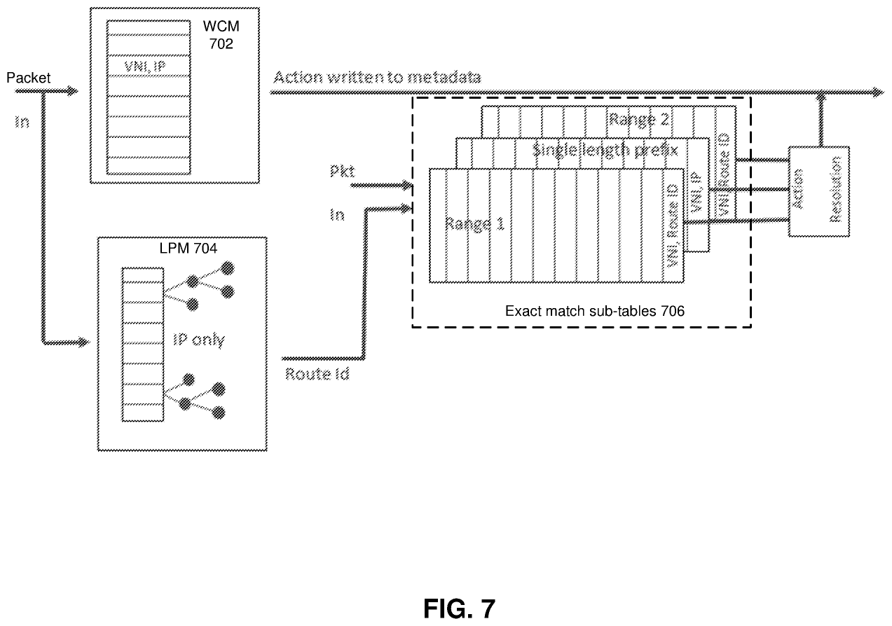

FIG. 7 depicts an example of use of Wild Card Match (WCM), LPM, and exact match lookup operations. A packet processing pipeline can perform WCM 702 in first pass along and LPM 704 of a trie data structure and perform exact match trie lookups 706. Exact match trie lookups 706 can be higher priority than WCM or LPM lookups as they contain higher prefixes. A WCM can occur using an upper or first /X bits of a key (e.g., destination IP address), where /X can represent matching upper or first X bits of the key with this rule.

One or two peaks (e.g., prefix length /X with highest number of entries) in the routing table distribution can be mapped separately in one or more exact match tables. For example, if a route distribution has a peak at /24 prefix (e.g., 24^{th} prefix of destination IP address), then the following configuration of exact match sub tables can be utilized. Exact match tables 706 can be split into 3 sub-tables by splitting IP address lookup into: range 1 (sub table 0), single length prefix (sub table 1), and range 2 (sub table 2). Exact match sub table 0 can be used for route virtualization for prefixes /25 to /31 of destination IP address, which matches on Route_id from trie action and VNI to get the final action to perform on the packet. Exact match sub table 1 can be used for /24 peak of destination IP address with a match on VNI and IP address to get the final action to perform on the packet. Exact match sub table 2 for routing virtualization can be used for prefixes /8 to /23 which matches on Route_id from trie and VNI to get an action to perform on the packet. WCM lookup can be performed to determine an action to perform on the packet if no match in sub-tables 0-2 is found. If no match is found despite attempted lookups by WCM 702, LPM 704, and exact match 706, the packet can be dropped or a processor can perform exception handling on the packet.

For example, the 8 lowest prefixes can be in WCM. If the first /0 to /7 prefixes are included in a WCM lookup, exact match table size can be reduced to under a table limit in memory for exact match. Other number of zones can be used.

The following describes an example manner to add entries to tables accessed by operations of LPM 704 and exact match 706. Adding new routes can occur by adding entry first to exact match table and then add entry to LPM trie (to avoid race condition when packet processing pipeline is processing packets).

| Scenario | Process for adding entries |
|---|---|
| Add a {tunnel identifier, LPM} prefix | Add exact match for tunnel identifier |
| where the LPM prefix exists | |
| Add a {tunnel identifier, LPM} prefix | Add entry in exact match first and then add entry |
| where the LPM prefix is new and no larger | in LPM |
| or smaller prefix exists | |
| Add a {tunnel identifier, LPM} prefix | Add multiple entries in exact match table for this |
| where there is a larger prefix for another | tunnel identifier and then add entry in LPM |
| tunnel identifier | |
| Add a {tunnel identifier, LPM} prefix | Add extra entry in exact match table to other |
| where there is a smaller prefix for another | tunnel entry and then entry for this tunnel entry |
| tunnel identifier | and then finally the LPM entry |

An example of entry addition is described for {VNI1, a.b.*->Action 1} and {VNI2, a.b.c.*->Action 2}. An LPM trie is flattened by removing VNI1 and VNI2. VNI1 and VNI2 both have a.b.c.* (route_id 4820) & a.b.* (route_id 380) entries. However, lookup for destination IP addresses arising from packets from VNI1 and VNI2 will match to same LPM entry.

In an exact match (next pass): {VNI1, 380} matches to Action1, {VNI1, 4820} matches to Action1, {VNI2, 4820} matches to Action 2. Note {VNI1, 4820} is added to exact match table, which will have the same action set as that of {VNI1, 380}. Packet with destination IP address of a.b.c.d with VNI1 can hit a.b.c.* in the flat LPM lookup and this was not part of VNI1 route set, but a.b.* is part of VNI1 route set.

The following describes an example manner to remove entries from LPM and exact match tables. For deleting an entry, first delete entry in LPM and then delete entry in SEM.

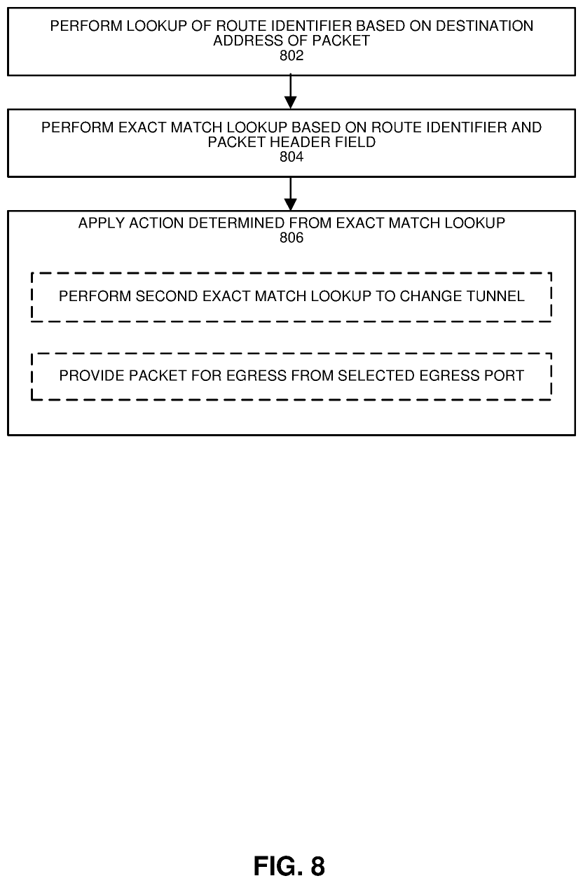

FIG. 8 depicts an example process. The process can be performed by a packet processing pipeline. At 802, perform lookup of entries of a route identifier based on a destination Internet Protocol (IP) address. In some examples, lookup can be based on LPM and/or WCM. In some examples, a route lookup rule set can be divided into multiple priority ranges with the lower priority range looked up in WCM and higher priority ranges can be looked up based on LPM and/or exact match lookups.

At 804, perform exact match lookup of an action to perform on the packet based on the route identifier and at least one packet header field value. For example, the at least one packet header field value can include a virtual local area network identifier, such as a virtual tunnel identifier. In some examples, the packet can be transmitted using a tunnel protocol and the virtual tunnel identifier can be a tunnel identifier. In addition, runtime programming of the table entries can be performed, to add or delete entries in lookup tables, as described herein. In some examples, control plane software and/or a device driver for a switch or network interface device can automatically configure the lookup operations in 802 and 804 by adding or deleting entries or configuring use of lookups of FIGS. 4, 5, and/or 6.

At 806, the action determined from exact match lookup can be performed. For example, the action can cause a second lookup of a second tunnel identifier for the packet. For example, the action can cause an egress of the packet from a particular egress port for transmission to a selected next hop. For example, the action can cause providing the packet to a process executed by a host system that executed another process that provided the packet. In some examples, the exact match lookup can access an exact match table. In some examples, the exact match lookup can be iterated so that multiple exact match lookup operations occur in series.

FIG. 9 depicts a system. In some examples, lookups for entries using LPM and exact match can be performed for packets, as described herein. System 900 includes processor 910, which provides processing, operation management, and execution of instructions for system 900. Processor 910 can include any type of microprocessor, central processing unit (CPU), graphics processing unit (GPU), XPU, processing core, or other processing hardware to provide processing for system 900, or a combination of processors. An XPU can include one or more of: a CPU, a graphics processing unit (GPU), general purpose GPU (GPGPU), and/or other processing units (e.g., accelerators or programmable or fixed function FPGAs). Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a display that provides an output to a user. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a programmable or fixed function offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 and/or processes 936 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others. OS 932 or driver can enable or disable use of lookup modes described with respect to FIG. 5, 6, or 7 by a switch or other packet processing circuitry as well as configure entries for lookup.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 technology to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. In some examples, packet processing device or network interface device 950 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 1, 2, 3, or 4.

In some examples, lookups for entries using LPM and exact match can be performed for packets using programmable pipelines of network interface 950, as described herein.

In one example, system 900 includes one or more input/output (I/O) interface(s) 960. I/O interface 960 can include one or more interface components through which a user interacts with system 900. Peripheral interface 970 can include any hardware interface not specifically mentioned above. Peripherals refer generally to devices that connect dependently to system 900.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. A non-volatile memory (NVM) device is a memory whose state is determinate even if power is interrupted to the device.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 900 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.
Example 1 includes one or more examples, and includes an apparatus that includes: an interface and circuitry coupled to the interface, the circuitry configured to: perform a route lookup for a packet based on first and second lookup operations, wherein the first lookup operation comprises a longest prefix match (LPM) to output a route identifier based on a destination Internet Protocol (IP) address of the packet and wherein the second look up operation comprises an exact match operation to determine an action based on the route identifier and a packet header.
Example 2 includes one or more examples, wherein the first lookup operation is to access a trie data structure and the second lookup operation is to access an exact match table.
Example 3 includes one or more examples, wherein the packet header comprises a virtual network identifier (VNI).
Example 4 includes one or more examples, wherein the action comprises one or more of: egress port determination, determination of a tunnel identifier, packet header modification to include a tunnel identifier in a header field, or cryptographic processing of the packet.
Example 5 includes one or more examples, wherein the packet is received using a tunnel protocol and wherein the tunnel protocol is based on one or more of: Multiprotocol Label Switching (MPLS), Label Distribution Protocol (LDP), Segment Routing over IPv6 dataplane (SRv6), Virtual Extensible LAN (VXLAN) tunneled traffic, or GENEVE tunneled traffic.
Example 6 includes one or more examples, wherein the circuitry comprises a packet processing pipeline that is to perform match-action operations based on the first and second look up operations.
Example 7 includes one or more examples, wherein the circuitry is to perform the first and second look up operations based on combination of outer and inner header of the packet.
Example 8 includes one or more examples, wherein a source of the packet comprises a virtual machine, container, or microservice.
Example 9 includes one or more examples, and includes a switch system on chip (SoC), wherein the switch SoC comprises the interface and the circuitry.
Example 10 includes one or more examples, and includes at least one ingress port, at least one egress port, and a memory, wherein the at least one ingress port, the at least one egress port, and the memory are communicatively coupled to the switch SoC.
Example 11 includes one or more examples, and includes a method comprising: performing a first lookup operation for a packet by a longest prefix match (LPM) to determine a route identifier based on a destination Internet Protocol (IP) address of the packet and performing a second look up operation by an exact match operation to determine an action based on the route identifier and a packet header.
Example 12 includes one or more examples, wherein the first lookup operation is to access a trie data structure.
Example 13 includes one or more examples, wherein the packet header comprises a virtual tunnel identifier.
Example 14 includes one or more examples, wherein the action comprises one or more of: egress port determination, determination of a tunnel identifier, packet header modification to include a tunnel identifier in a header field, or cryptographic processing of the packet.
Example 15 includes one or more examples, wherein the packet is received using a tunnel protocol and wherein the tunnel protocol is based on one or more of: Multiprotocol Label Switching (MPLS), Label Distribution Protocol (LDP), Segment Routing over IPv6 dataplane (SRv6), Virtual Extensible LAN (VXLAN) tunneled traffic, or GENEVE tunneled traffic.
Example 16 includes one or more examples, and includes a non-transitory computer-readable medium comprising instructions stored thereon, that if executed by circuitry of a network interface device, cause the circuitry of the network interface device to: configure circuitry of a network interface device to: perform a first lookup operation for a packet by a longest prefix match (LPM) to determine a route identifier based on a destination Internet Protocol (IP) address of the packet and perform a second look up operation by an exact match operation to determine an action based on the route identifier and a packet header.
Example 17 includes one or more examples, wherein the packet header comprises a virtual tunnel identifier.
Example 18 includes one or more examples, wherein the action comprises one or more of: egress port determination, determination of a tunnel identifier, packet header modification to include a tunnel identifier in a header field, or cryptographic processing of the packet.
Example 19 includes one or more examples, wherein the packet is received using a tunnel protocol and wherein the tunnel protocol is based on one or more of: Multiprotocol Label Switching (MPLS), Label Distribution Protocol (LDP), Segment Routing over IPv6 dataplane (SRv6), Virtual Extensible LAN (VXLAN) tunneled traffic, or GENEVE tunneled traffic.
Example 20 includes one or more examples, wherein the network interface device comprises one or more of: network interface controller (NIC), switch, SmartNIC, router, forwarding element, infrastructure processing unit (IPU), data processing unit (DPU), or virtual switch.

What is claimed is:

1. An apparatus comprising:
an interface and
circuitry coupled to the interface, the circuitry configured to:
perform a route lookup for a packet based on first and second lookup operations, wherein the first lookup operation comprises a longest prefix match (LPM) to output a route identifier based on a destination Internet Protocol (IP) address of the packet and wherein the second look up operation comprises an exact match operation to determine an action based on the route identifier and a packet header.

2. The apparatus of claim 1, wherein the first lookup operation is to access a trie data structure and the second lookup operation is to access an exact match table.

3. The apparatus of claim 1, wherein the packet header comprises a virtual network identifier (VNI).

4. The apparatus of claim 1, wherein the action comprises one or more of: egress port determination, determination of a tunnel identifier, packet header modification to include a tunnel identifier in a header field, or cryptographic processing of the packet.

5. The apparatus of claim 1, wherein the packet is received using a tunnel protocol and wherein the tunnel protocol is based on one or more of: Multiprotocol Label Switching (MPLS), Label Distribution Protocol (LDP), Segment Routing over IPv6 dataplane (SRv6), Virtual Extensible LAN (VXLAN) tunneled traffic, or GENEVE tunneled traffic.

6. The apparatus of claim 1, wherein the circuitry comprises a packet processing pipeline that is to perform match-action operations based on the first and second look up operations.

7. The apparatus of claim 1, wherein the circuitry is to perform the first and second look up operations based on combination of outer and inner header of the packet.

8. The apparatus of claim 1, wherein a source of the packet comprises a virtual machine, container, or microservice.

9. The apparatus of claim 1, comprising a switch system on chip (SoC), wherein the switch SoC comprises the interface and the circuitry.

10. The apparatus of claim 9, comprising at least one ingress port, at least one egress port, and a memory, wherein the at least one ingress port, the at least one egress port, and the memory are communicatively coupled to the switch SoC.

11. A method comprising:
performing a first lookup operation for a packet by a longest prefix match (LPM) to determine a route identifier based on a destination Internet Protocol (IP) address of the packet and
performing a second look up operation by an exact match operation to determine an action based on the route identifier and a packet header.

12. The method of claim 11, wherein the first lookup operation is to access a trie data structure.

13. The method of claim 11, wherein the packet header comprises a virtual tunnel identifier.

14. The method of claim 11, wherein the action comprises one or more of: egress port determination, determination of a tunnel identifier, packet header modification to include a tunnel identifier in a header field, or cryptographic processing of the packet.

15. The method of claim 11, wherein the packet is received using a tunnel protocol and wherein the tunnel protocol is based on one or more of: Multiprotocol Label Switching (MPLS), Label Distribution Protocol (LDP), Segment Routing over IPv6 dataplane (SRv6), Virtual Extensible LAN (VXLAN) tunneled traffic, or GENEVE tunneled traffic.

16. A non-transitory computer-readable medium comprising instructions stored thereon, that if executed by circuitry of a network interface device, cause the circuitry of the network interface device to:
configure circuitry of a network interface device to:
perform a first lookup operation for a packet by a longest prefix match (LPM) to determine a route identifier based on a destination Internet Protocol (IP) address of the packet and
perform a second look up operation by an exact match operation to determine an action based on the route identifier and a packet header.

17. The non-transitory computer-readable medium of claim 16, wherein the packet header comprises a virtual tunnel identifier.

18. The non-transitory computer-readable medium of claim 16, wherein the action comprises one or more of: egress port determination, determination of a tunnel identifier, packet header modification to include a tunnel identifier in a header field, or cryptographic processing of the packet.

19. The non-transitory computer-readable medium of claim 16, wherein the packet is received using a tunnel protocol and wherein the tunnel protocol is based on one or more of: Multiprotocol Label Switching (MPLS), Label Distribution Protocol (LDP), Segment Routing over IPv6 dataplane (SRv6), Virtual Extensible LAN (VXLAN) tunneled traffic, or GENEVE tunneled traffic.

20. The non-transitory computer-readable medium of claim 16, wherein the network interface device comprises one or more of: network interface controller (NIC), switch, SmartNIC, router, forwarding element, infrastructure processing unit (IPU), data processing unit (DPU), or virtual switch.
